(19) United States
(12) Patent Application Publication
(10) Pub. No.: US 2012/0174635 A1
(43) Pub. Date: Jul. 12, 2012

(54) ANTI-THEFT SEAL, PARTICULARLY ADAPTED FOR APPLICATION TO SLENDER PARTS OF PRODUCTS SUCH AS EARPIECES OF EYEGLASSES AND THE LIKE

(75) Inventor: Giulietta Andreina Pierobon, Valdagno (IT)

(73) Assignees: Plasti-Max S.P.A.; Technology Tags S.R.L.

(21) Appl. No.: 13/497,734

(22) PCT Filed: Sep. 20, 2010
(86) PCT No.: PCT/EP2010/063814

§ 371 Date: Mar. 22, 2012

(30) Foreign Application Priority Data
Sep. 22, 2009 (IT) PD2009A000275

(51) Int. Cl. E05B 47/00

(52) U.S. Cl. 70/276

(57) ABSTRACT

An anti-theft seal, particularly adapted for application to slender parts of products such as earpieces of eyeglasses, which comprises two complementary jaws, which are provided, on opposite sides of a central part thereof adapted to grip a product, with elements for mutual retention which can be deactivated by magnetic action, at least one plate, which is connected to at least one first one of the jaws, in the central part, so as to tilt with respect to at least one extraction direction of a slender part of product which during use is comprised between the jaws, for the jamming of the plate against the slender part upon an attempt to extract it from the anti-theft seal.

The present invention relates to an anti-theft seal, particularly adapted for application to slender parts of products such as earpieces of eyeglasses and the like.

### BACKGROUND OF THE INVENTION

Several models of seals adapted to retain an anti-theft device to a slender part of a product are currently known.

For example, in order to retain an anti-theft device to earpieces of eyeglasses or the like, a seal hinged along one edge is known which has two jaw-like parts which are mutually hinged on one side and have, on the other side, a connection device adapted for their mutual retention.

Thus, the seal can be fixed to the earpiece by closing it so that the two jaw-like parts include it, locking themselves to each other and to the earpiece by means of the connection device.

Such connection device generally comprises tabs which are provided with teeth complementarily and are connected to the opposite jaw-like ends, so that when they are closed onto each other such tabs couple to each other by means of the teeth that mutually engage.

In order to release the earpiece, a tool is provided which is adapted to divaricate the tabs so as to disengage their teeth and allow the separation of the jaw-like parts.

Contrast to sliding the seal off the product is provided by the friction between the central parts of the jaw-like parts, between which the slender part of the product, for example the earpiece, is clamped.

In particular, the friction force becomes more effective in contrasting the separation of the seal from the product as the jaw-like parts are mutually fastened more firmly.

This type of seal, despite being greatly appreciated, is however inadequate to meet the need to retain delicate products or products that have a delicate surface finish, which might be damaged by a firm constriction applied to them by the jaw-like parts in order to ensure an effective grip thereof.

Moreover, these seals hinged along one edge are unsuitable to be fixed to earpieces having a substantial thickness, since in this case the jaw-like parts that are closed thereon to lock the seal thereat are excessively divaricated, fully to the disadvantage of an effective retention of the seal on the product.

### SUMMARY OF THE INVENTION

The aim of the present invention is to provide a seal that overcomes the drawbacks of currently known seals and further meets the described requirement, thus allowing to retain, on a slender part of a product, anti-theft devices in an effective and simultaneously delicate manner, so as to not damage it.

Within this aim, an object of the invention is to propose a seal that can adapt easily to slender products that have even greatly different thicknesses, while ensuring an effective connection thereto.

Another object of the invention is to provide a seal that can be applied easily to a product and can be easily separated correctly from it by means of an apparatus that is simple and easy to use.

Another object of the invention is to propose a seal which, in conditions for correct use, applies to the product with which it is associated a modest grip force, but instead clamps forcefully onto it if an attempt is made to separate it from the product.

Another object of the invention is to propose a seal that is structurally simple and easy to use and can be manufactured with low costs.

This aim and these and other objects that will become better apparent hereinafter are achieved by an anti-theft seal, particularly adapted for application to slender parts of products such as earpieces of eyeglasses and the like, comprising two complementary jaws which are provided, on opposite sides of a central part thereof adapted to grip a product, with means for mutual retention, which can be deactivated by magnetic action, characterized in that it comprises at least one plate, which is connected to at least one first one of said jaws, in said central part, so as to tilt with respect to at least one extraction direction of a slender part of the product which during use is comprised between said jaws, for the jamming of said plate against said slender part upon an attempt to extract it from said anti-theft seal, in order to contrast it.

### BRIEF DESCRIPTION OF THE DRAWINGS

Further characteristics and advantages of the invention will become better apparent from the following detailed description of a preferred but not exclusive embodiment of the anti-theft seal according to the invention, illustrated by way of non-limiting example in the accompanying drawings, wherein:

FIG. 1 is a longitudinal sectional view of an anti-theft seal according to the invention;

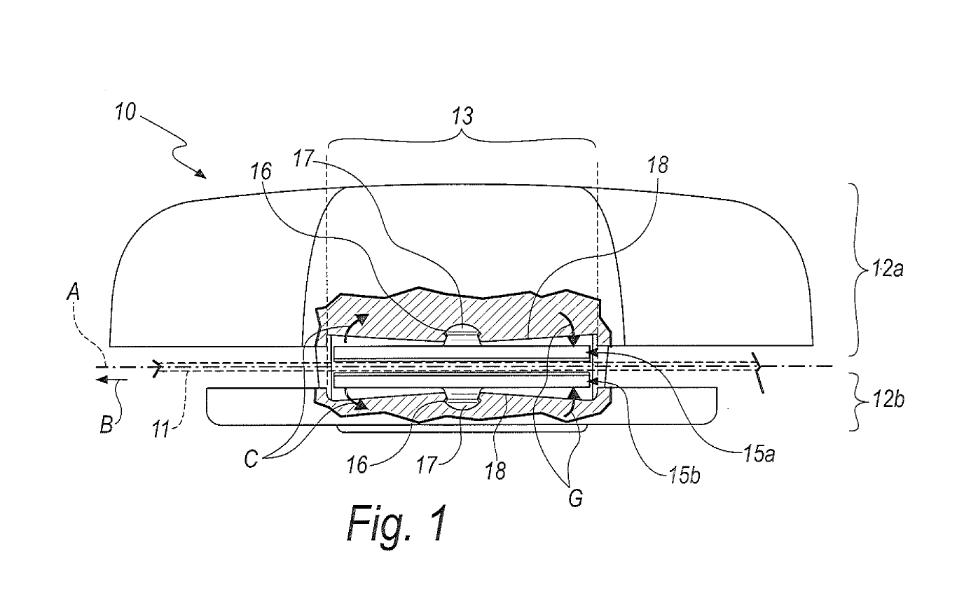

FIG. 2 is an exploded perspective view of the anti-theft seal according to the invention;

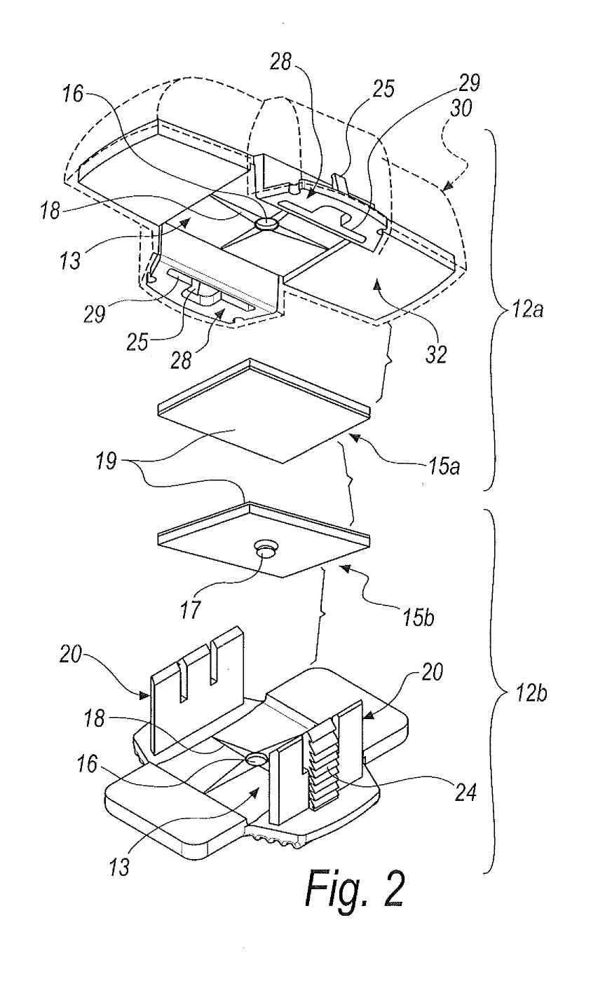

FIGS. 3a and 3b are transverse sectional views of the anti-theft seal according to the invention in the open and closed condition.

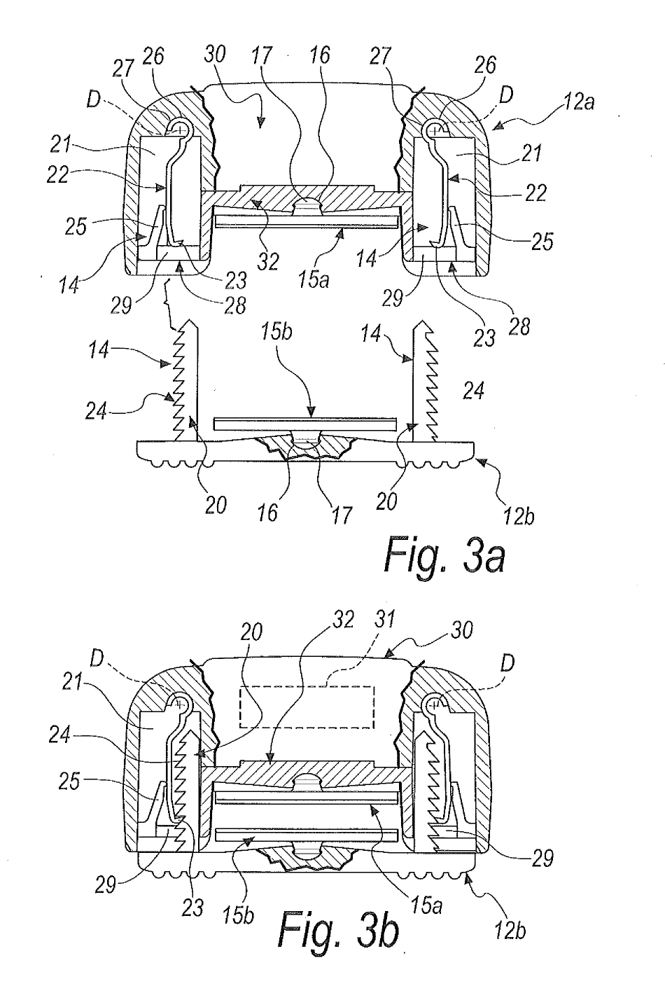

### DESCRIPTION OF THE PREFERRED EMBODIMENTS

It is noted that anything found to be already known during the patenting process is understood not to be claimed and to be the subject of a disclaimer.

With reference to the figures, the reference numeral 10 generally designates an anti-theft seal, particularly adapted for application to slender parts 11 of products such as earpieces of eyeglasses and the like, comprising two complementary jaws 12a and 12b which are provided, on opposite sides of a central part 13 thereof adapted to grip a product, with means 14 for mutual retention, which can be deactivated by magnetic action.

According to the invention, the anti-theft seal 10 comprises two plates 15a and 15b, which are connected to the jaws 12a and 12b in the corresponding central parts 13, so as to tilt with respect to at least one extraction direction A of a slender part of the product which during use is comprised between the jaws 12a and 12b.

Thus, when the anti-theft seal 10 is in use, i.e., the jaws 12a and 12b are closed onto the slender part 11 of the product, if a traction force B is applied to such part in order to extract it from the seal 10, the plates 15a and 15b, by way of their friction with the slender part 11, tilt with rotations C, jamming against the slender part 11, contrasting its extraction.

In general, in alternative embodiments of the anti-theft seal according to the invention, which are not shown in the accompanying figures, such seal comprises at least one of such plates.

In particular, for example, it can comprise just one of such plates, connected to one of the jaws in such central part, so as to tilt with respect to at least one extraction direction of a slender part of the product that during use is comprised between the jaws.

In this case, upon an attempt to extract the product from the anti-theft seal, the plate tilts, jamming against the slender part so to contrast its extraction.

Moreover, the anti-theft seal 10 conveniently has
an accommodation seat 16 for a connecting tab 17, which is adapted to connect the plates 15a and 15b to the central parts 13,
the connecting tab 17, in a manner which is complementary to the accommodation seat 16.

Advantageously, in the embodiment described here, the accommodation seat 16 is formed at the top of a raised portion 18 that is provided centrally on the central part 13 of the jaws 12a and 12b.

At the same time, the connecting tab 17 protrudes from a face of the plates 15a and 15b by an extent that is greater than the depth of the accommodation seat 16.

In a substantially equivalent manner, in alternative embodiments of the invention, not shown in the accompanying figures, the accommodation seat can be provided vice versa on a face of the plate, the tab protruding from the central part of the jaw.

In any case, the connecting tab 17 inserted in the accommodation seat 16 forms a fulcrum for the tilting of the plates 15a and 15b with respect to the respective central parts 13, at least with respect to the extraction direction A.

Conveniently, there is also a gasket 19 for contrasting the sliding between the plates 15a and 15b and a product against which they abut during use.

The gasket 19 is advantageously made of rubber or the like and is associated with a face of the plates 15a and 15b that is adapted to abut against the product to which the anti-theft seal 10 is to be retained.

The retention means 14 preferably comprise toothed tabs 20, which protrude from one of the jaws 12a and 12b, for example from the second jaw 12b, the first jaw 12a having corresponding insertion seats 21 for the toothed tabs 20.

Lugs 22 are conveniently arranged in the insertion seats 21 and are generally provided with at least one tooth 23 for engagement with sets of teeth 24 of the toothed tabs 20.

The lugs 22 preferably are magnetically reactive and are supported in the insertion seats 21 so that they can be divaricated from the toothed tabs 20 in contrast with elastic means provided thereat, the lugs 22 gripping the toothed tabs 20 during use.

More particularly, such elastic means advantageously comprise elastic wings 25, which protrude into the insertion seats 21 in order to push the lugs 22 against the toothed tabs 20, with which they engage during use.

Furthermore, the lugs 22 are preferably made of magnetically reactive metallic material, so that they can be divaricated from the toothed tabs 20 by the action of a magnetic field, generated for example by a magnet which for this purpose is arranged adjacent to the anti-theft seal 10.

Moreover, the lugs 22 have a tooth 23 at one of their ends, which is adapted to engage the sets of teeth 24, and have at their other end a curl 26 which is substantially cylindrical and is accommodated in a contoured pivoting seat 27 formed in the insertion seats 21, so as to be able to tilt with respect to the central axis D, which is common to the curl 26 and to the pivoting seat 27 in which it is accommodated.

Thus, upon closure of the jaws 12a and 12b onto each other, the toothed tabs 20 enter the insertion seats 21, where they divaricate the lugs 22, by tilting about the central axis D, in contrast with the action of the elastic wings 25.

Thus, the tooth 23 of the lugs 22 slides in a ratchet-like fashion on the sets of teeth 24, which are conveniently sawtooth-shaped, and is pushed against them by the elastic wings 25.

The separation of the jaws 12a and 12b, once the toothed tabs 20 have been inserted in the insertion seats 21, is thus prevented by the engagement of the teeth 23 of the lugs 22 with the sets of teeth 24.

For the separation of the jaws 12a and 12b, it is therefore necessary to divaricate the lugs 22 from the toothed tabs 20, for example by means of magnets which are arranged next to the anti-theft seal 10 for this purpose.

In the embodiment of the invention described here, by way of non-limiting example, the sets of teeth 24 conveniently are formed on the toothed tabs 20 so as to be offset with respect to each other substantially by half a tooth.

In this manner, although the retention effectiveness of the jaws 12a and 12b with respect to each other is not compromised, their separation is facilitated when the lugs 22 are divaricated by the toothed tabs 20.

Since the sets of teeth 24 are offset, only one of the teeth 23 of the two lugs 22 in fact engages them completely, and so when they are divaricated first the lug 22 that engages more weakly the corresponding toothed tab 20 is disengaged, thus facilitating the disengagement of the other lug 22.

Moreover, the anti-theft seal 10 comprises conveniently masks 28 for contrasting the access of tools for divaricating the lugs 22 from the toothed tabs 20 when they are mutually engaged during use.

The masks 28 conveniently are provided at the mouths of the insertion seats 21 and have an opening 29 which is shaped strictly complementarily with respect to the cross-section of the toothed tabs 20, which during use are inserted in the insertion seats 21 through the openings 29.

More particularly, the jaw 12a, which has the insertion seats 21, comprises
a shell 30, which forms internally a compartment for an anti-theft device 31 and the insertion seats 21 laterally to such compartment,
a cover 32 for the shell 30, which forms centrally the central part 13, having laterally thereto lobes which form the masks 28 at the insertion seats 21, the mouths of which are covered by the masks 28 when the cover 32 is associated with the shell 30.

Therefore, thanks to the anti-theft seal 10, according to the invention, it is possible to retain an anti-theft device 31 on a product by means of a closing force of the jaws 12a and 12b on the slender part 11 thereof that can even be very small.

In fact, although the pressure force of the plates 15a and 15b against the slender part 11 is modest, when an attempt is made to extract such slender part from the anti-theft seal, the plates 15a and 15b jam against the slender part 11, contrasting their extraction.

In practice it has been found that the invention achieves the intended aim and objects, providing an anti-theft seal that allows to retain effectively but delicately a slender part of a product so as to not damage it.

Furthermore, an anti-theft seal according to the invention allows to adapt easily to slender products that have even broadly different thicknesses, while ensuring an effective connection to them, thanks to the fact of providing the two jaws so that they can be closed onto each other in a manner that can be modulated.

Moreover, an anti-theft seal according to the invention can be applied to a product easily and be separated correctly from it by means of a tool which is simple and easy to use, such as appropriately arranged magnets.

The invention thus conceived is susceptible of numerous modifications and variations, all of which are within the scope of the appended claims; all the details may further be replaced with other technically equivalent elements.

In practice, the materials employed, so long as they are compatible with the specific use, as well as the contingent shapes and dimensions, may be any according to requirements and to the state of the art.

The disclosures in Italian Patent Application No. PD2009A000275 from which this application claims priority are incorporated herein by reference.

Where technical features mentioned in any claim are followed by reference signs, those reference signs have been included for the sole purpose of increasing the intelligibility of the claims and accordingly such reference signs do not have any limiting effect on the interpretation of each element identified by way of example by such reference signs.

1-10. (canceled)

11. An anti-theft seal, particularly adapted for application to slender parts of products such as earpieces of eyeglasses and the like, comprising two complementary jaws which are provided, on opposite sides of a central part thereof adapted to grip a product, with means for mutual retention which can be deactivated by magnetic action, comprising at least one plate, which is connected to at least one first one of said jaws, in said central part, so as to tilt with respect to at least one extraction direction of a slender part of product which during use is comprised between said jaws, for the jamming of said at least one plate against said slender part upon an attempt to extract it from said anti-theft seal, in order to contrast it.

12. The anti-theft seal according to claim 11, comprising
a first plate, of said at least one plate, which is connected so that it can tilt to a first one of said jaws, in said central part, and
a second plate, of said at least one plate, which is connected so that it can tilt to the second one of said jaws,
said first plate and said second plate being arranged in said central parts of said jaws in a corresponding manner, during use a slender part of a product being comprised between said plates which abut against it.

13. The anti-theft seal according to claim 11, further comprising
an accommodation seat for a tab for connecting said plate to said central part, said accommodation scat being formed selectively on a face of said at least one plate or on said central part,
said connecting tab, which protrudes selectively, and complementarily to said accommodation seat, on said central part or on one face of said at least one plate, by an extent that is greater than the depth of said accommodation seat,
said connecting tab inserted in said accommodation seat forming a fulcrum for the tilting of said at least one plate with respect to said central part, at least with respect to said extraction direction.

14. The anti-theft seal according to claim 11, further comprising a gasket for contrasting the sliding between said at least one plate and a product against which said at least one plate abuts during use, said gasket being associated with a face of said at least one plate that is adapted to abut against the product to which said seal is to be retained.

15. The anti-theft seal according to claim 11, wherein said retention means comprises toothed tabs, which protrude from one of said jaws, the other one of said jaws having corresponding insertion seats for said toothed tabs, lugs being arranged in said insertion seats and having at least one tooth for engagement with sets of teeth of said toothed tabs to contrast the extraction of said tabs from said insertion seats, said lugs being magnetically reactive and being supported in said insertion seats so that they can be divaricated, in contrast with elastic means provided thereat, from said toothed tabs which they grip during use.

16. The anti-theft seal according to claim 15, wherein said lugs are made of magnetically reactive metallic material.

17. The anti-theft seal according to claim 15, wherein said lugs have a tooth at one of their ends, which is adapted to engage said sets of teeth, having at their other end a substantially cylindrical curl which is accommodated in a contoured pivoting seat formed in said insertion seats.

18. The anti-theft seal according to claim 15, wherein said sets of teeth are formed on said toothed tabs so as to be offset substantially by half a tooth.

19. The anti-theft seal according to claim 15, further comprising at least one mask for contrasting the access of tools for divaricating said lugs from said toothed tabs, when they are mutually engaged during use, said at least one mask being provided at the mouth of said insertion seats and having an opening which is shaped strictly complementarily with respect to the cross-section of said toothed tabs, which during use are inserted in said insertion seats through said opening.

20. The anti-theft seal according to claim 15, wherein one of said jaws, which has said insertion seats, comprises
a shell, which forms internally a compartment for an anti-theft device and said insertion seats laterally to said compartment,
a cover for said shell, which forms centrally said central part and has, laterally thereto, lobes which form masks, of said at least one mask, at said insertion seats, the mouths of which are covered by said masks when said cover is associated with said shell.
